(19) United States
(12) Patent Application Publication
(10) Pub. No.: US 2021/0114416 A1
(43) Pub. Date: Apr. 22, 2021

(54) PNEUMATIC TIRE FOR AN ELECTRIC VEHICLE

(71) Applicant: The Goodyear Tire & Rubber Company, Akron, OH (US)

(72) Inventors: Remi Lambillotte, Colmar-Berg (LU); Frederic Ngo, Mersch (LU); Gilles Reichling, Vichten (LU); Jean Woelffel, Longwy (FR); Philippe Joseph Willy Proehs, Grevenmacher (LU); Pierre Courtoy, Colmar-Berg (LU); Vincent Jean-Emile Decouvreur, Florennes (BE); Armand Rene Gabriel Leconte, Insenborn (LU); Sebastien Willy Fontaine, Vichten (LU); Olivier Ruffier-Lanche, Marche-en-Famenne (BE); Serge Guillaume Feltes, Hagondange (FR)

(21) Appl. No.: 17/018,124

(22) Filed: Sep. 11, 2020

Related U.S. Application Data
(60) Provisional application No. 62/923,814, filed on Oct. 21, 2019.

(51) Int. Cl. B60C 11/01

(52) U.S. Cl. CPC B60C 11/01; B60C 2200/04

(57) ABSTRACT

A pneumatic tire for an electric vehicle includes a pair of bead areas, a ground-contacting tread disposed radially outwardly of the pair of bead areas, and a pair of sidewalls. Each sidewall extends from a respective bead area to the tread. The tread joins each sidewall at a respective shoulder and the shoulders include an inboard shoulder and an outboard shoulder. A radius on the inboard shoulder is larger than a radius on the outboard shoulder. Physical features are formed on the tread, and each feature is formed in the shape of a fin. The features increase air flow towards an electric vehicle motor located inboardly of the tire. At least one of the fins includes a leading edge formed with micro-features.

### FIELD OF THE INVENTION

The invention relates to pneumatic tires. More particularly, the invention relates to a structure of a pneumatic tire that includes features for an electric vehicle.

### BACKGROUND OF THE INVENTION

In the manufacture of a pneumatic tire, the tire is typically built on the drum of a tire-building machine, which is known in the art as a tire building drum. Numerous tire components are wrapped about and/or applied to the drum in sequence, forming a cylindrical-shaped tire carcass. The tire carcass is then expanded into a toroidal shape for receipt of the remaining components of the tire, such as a belt package and a rubber tread. The completed toroidally-shaped unvulcanized tire carcass, which is known in the art at that stage as a green tire, is then inserted into a mold or press for forming of the tread pattern and curing or vulcanization.

As different types of vehicles are developed, the structural requirements of tires change. For example, for tires that are employed on electric vehicles, which are vehicles with electric drive systems, it is desirable to provide specific structural features on the tires which maximize the advantages of the electric drive systems.

As a result, it is desirable to provide a tire that includes features which increase the advantages of a drive system of an electric vehicle.

### SUMMARY OF THE INVENTION

According to an aspect of an exemplary embodiment of the invention, a pneumatic tire for an electric vehicle includes a pair of bead areas, a ground-contacting tread disposed radially outwardly of the pair of bead areas, and a pair of sidewalls, in which each sidewall extends from a respective bead area to the tread. The tread joins each sidewall at a respective shoulder. The shoulders include an inboard shoulder and an outboard shoulder, in which a radius on the inboard shoulder is larger than a radius on the outboard shoulder.

According to another aspect of an exemplary embodiment of the invention, a pneumatic tire for an electric vehicle includes a pair of bead areas, a ground-contacting tread disposed radially outwardly of the pair of bead areas, and a pair of sidewalls, in which each sidewall extends from a respective bead area to the tread. Physical features are formed on the tread, and each feature is formed in the shape of a fin. The features increase air flow towards an electric vehicle motor disposed inboardly of the tire.

According to another aspect of an exemplary embodiment of the invention, a pneumatic tire for an electric vehicle includes a pair of bead areas, a ground-contacting tread disposed radially outwardly of the pair of bead areas, and a pair of sidewalls, in which each sidewall extends from a respective bead area to the tread. Physical features are formed on the tread, and each feature is formed in the shape of a fin. At least one of the fins includes a leading edge that is formed with micro-features.

### Definitions

“Axial” and “axially” mean lines or directions that are parallel to the axis of rotation of the tire.

“Axially inward” and “axially inwardly” refer to an axial direction that is toward the equatorial plane of the tire.

“Axially outward” and “axially outwardly” refer to an axial direction that is away from the equatorial plane of the tire.

“Bead” means that part of the tire comprising an annular tensile member wrapped by ply cords and shaped, with or without other reinforcement elements such as flippers, chippers, apexes, toe guards and chafers, to fit the design rim.

“Carcass” means the tire structure apart from the belt structure, tread, undertread, and sidewall rubber over the plies, but including the beads.

“Chafer” means a layer of reinforcing material around the bead in the rim flange area to prevent chafing of the tire by the rim.

“Chipper” means a band of fabric or steelcord located in the bead area with the function of reinforcing the bead area and stabilizing the lower sidewall of the tire.

“Circumferential” means lines or directions extending along the perimeter of the surface of the annular tread perpendicular to the axial direction.

“Cord” means one of the reinforcement strands of which the plies in the tire are comprised.

“Equatorial plane (EP)” means the plane perpendicular to the tire's axis of rotation and passing through the center of its tread.

“Inboard” and “inboardly” refer to an axial direction that is toward the equatorial plane of the tire.

“Innerliner” means the layer or layers of elastomer or other material that form the inside surface of a tubeless tire and that contain the inflating fluid within the tire.

“Outboard” and “outboardly” refer to an axial direction that is away from the equatorial plane of the tire.

“Radial” and “radially” mean lines or directions that are perpendicular to the axis of rotation of the tire.

“Radially inward” and “radially inwardly” refer to a radial direction that is toward the central axis of rotation of the tire.

“Radially outward” and “radially outwardly” refer to a radial direction that is away from the central axis of rotation of the tire.

“Radial-ply tire” means a belted or circumferentially-restricted pneumatic tire in which the ply cords which extend from bead to bead are laid at cord angles between about 65 to about 90 degrees with respect to the equatorial plane of the tire.

### BRIEF DESCRIPTION OF THE DRAWINGS

The invention will be described by way of example and with reference to the accompanying drawings, in which:

FIG. 1 is a perspective view of an exemplary embodiment of the tire of the present invention mounted on a wheel;

FIG. 2 is an elevational outboard side view of the tire shown in FIG. 1;

FIG. 3 is an elevational end view of the tire shown in FIG. 1;

FIG. 4 is an elevational end view of the tire shown in FIG. 1, not mounted on a wheel;

FIG. 5 is a partial perspective view of the tire shown in FIG. 1 with a first air flow representation;

FIG. 6 is a partial perspective view of the tire shown in FIG. 1 with a second air flow representation;

FIG. 7 is a partial perspective view of the tire shown in FIG. 1 with an expanded view of a third air flow representation;

FIG. 8 is a partial perspective view of the tire shown in FIG. 1 with an expanded view of a fourth air flow representation;

FIG. 9 is a plan view of the tire shown in FIG. 1 with an air flow representation;

FIG. 10 is a perspective view of the tire shown in FIG. 1 with an air flow representation; and

FIG. 11 is an enlarged elevational end view of a portion of the tire shown in FIG. 1.

Similar numerals refer to similar parts throughout the drawings.

### DETAILED DESCRIPTION OF THE INVENTION

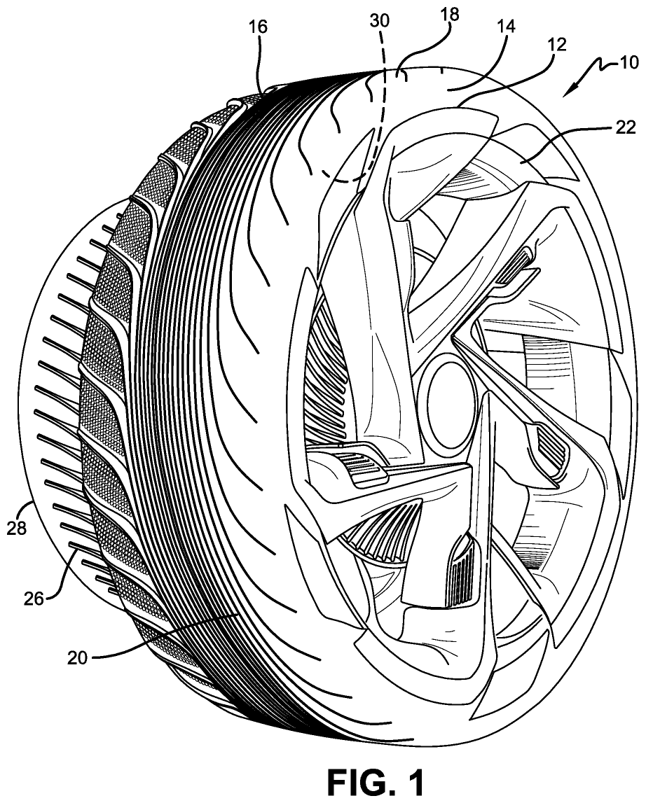

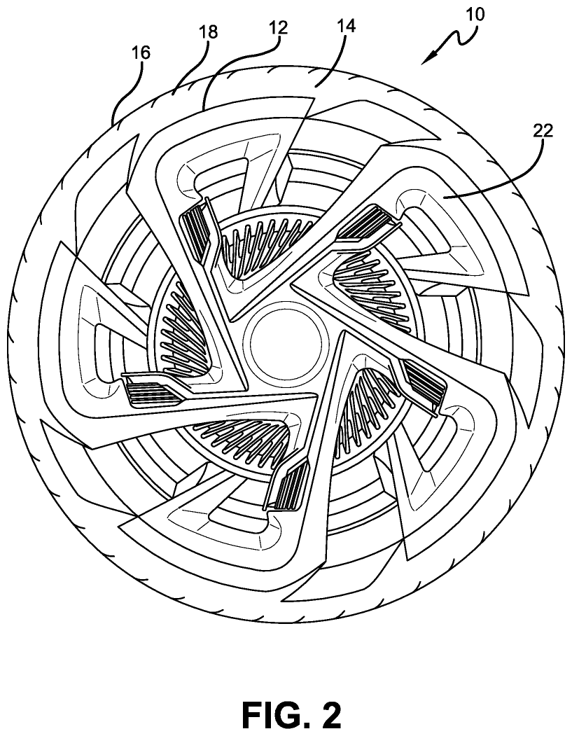

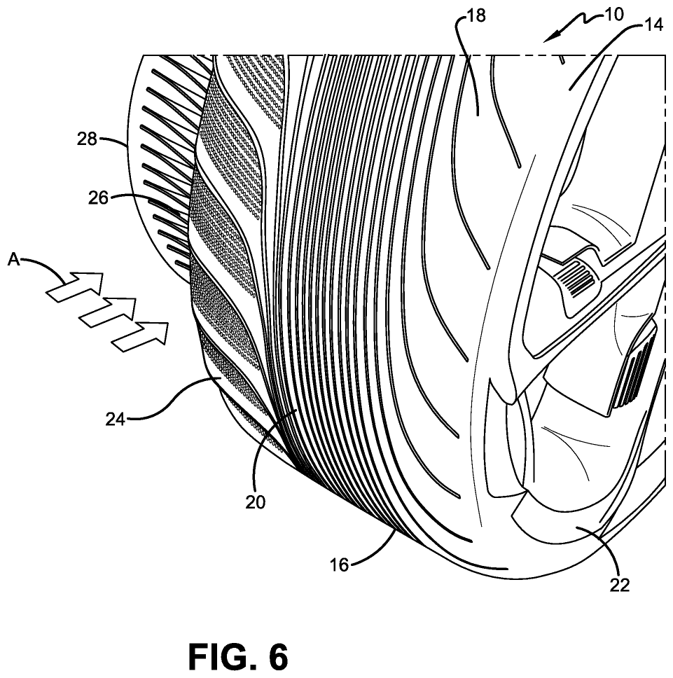

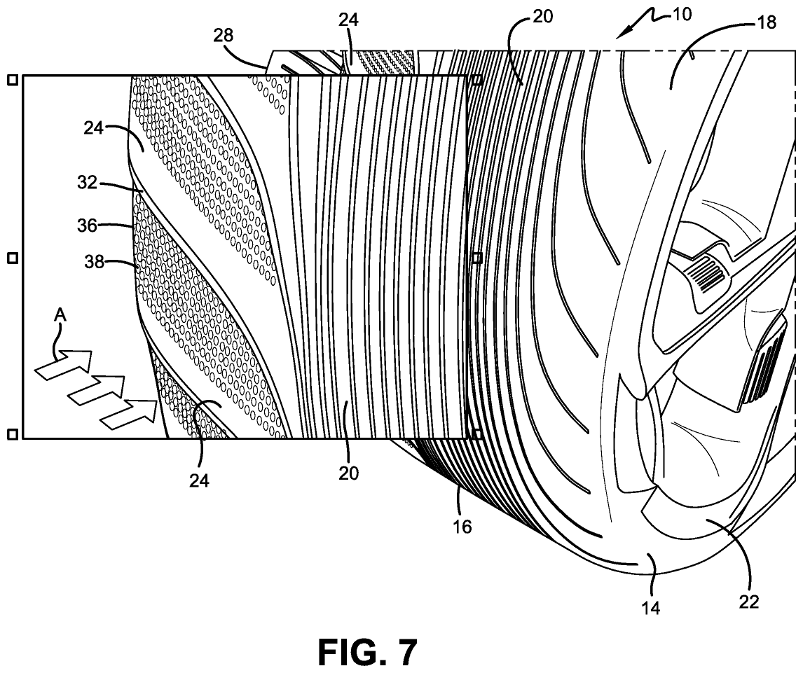

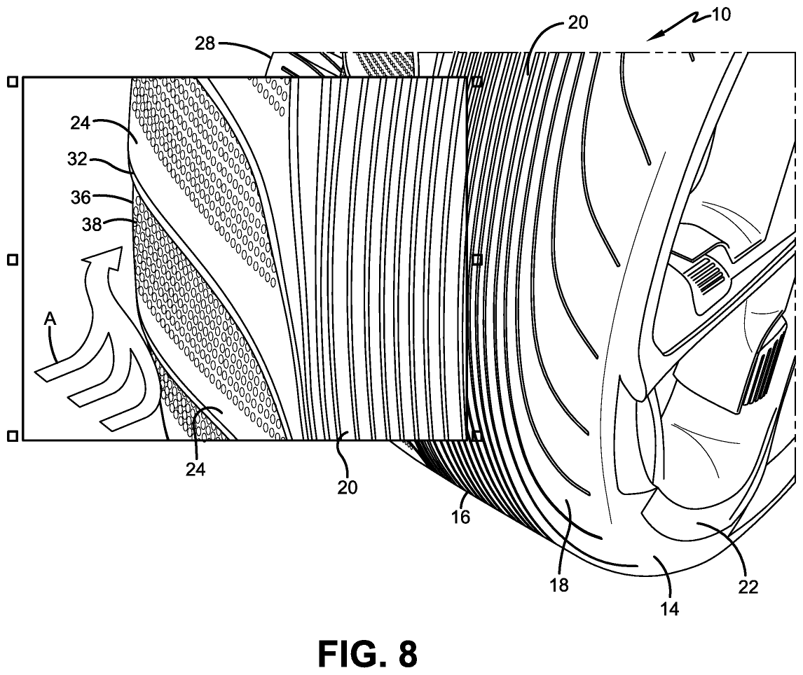

An exemplary embodiment of the tire of the present invention is shown in FIGS. 1 through 11 and indicated at 10.

Turning to FIGS. 1 through 3, the tire 10 preferably includes a pair of bead areas 12, each one of which is formed with a bead core (not shown) that is embedded in the bead area. Each one of a pair of sidewalls 14 extends radially outwardly from a respective bead area 12 to a ground-contacting tread 16. The tread 12 joins each sidewall 14 at a respective shoulder 18, and is formed with multiple tread elements 20. The tire 10 is reinforced by a carcass (not shown) that toroidally extends from one bead area 12 to the other bead area, as known to those skilled in the art. An innerliner (not shown) is formed on the inner or inside surface of the carcass. The tire 10 is mounted on a rim or wheel 22, as known in the art, and defines a cavity 30 when mounted.

The tire 10 employs aspects or features that increase the efficiency of an electric vehicle. The aspects or features cool down an electric motor of the vehicle and reduce aerodynamic drag to increase battery range of the vehicle.

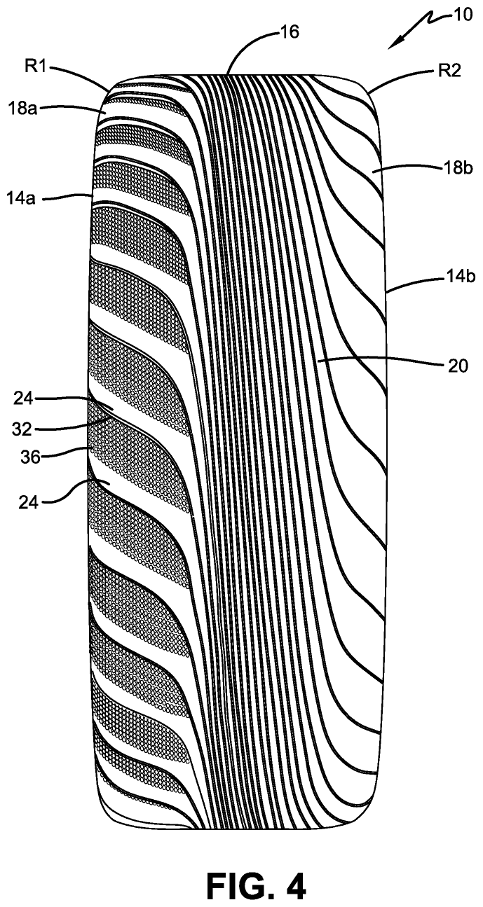

A first aspect or feature preferably includes a difference between the radius of each respective shoulder 18. More particularly, as shown in FIG. 4, the sidewalls 14 include an inboard sidewall 14a and an outboard sidewall 14b. The inboard sidewall 14a joins the tread 12 at an inboard shoulder 18a, and the outboard sidewall 14b joins the tread at an outboard shoulder 18b. The inboard shoulder 18a is formed with a first radius R1, and the outboard shoulder 18b is formed with a second radius R2. The first radius R1, which is the radius on the inboard shoulder 18a, is larger or rounder than the second radius R2, which is the radius on the outboard shoulder 18b. The difference of the radius of each shoulder 18, in which the radius R1 of the inboard shoulder 18a is larger than the radius R2 of the outboard shoulder 18b of the tire 10 drives cool air, which has been directed to the tire, towards an electric vehicle motor that is disposed inboardly of the rim or wheel 22.

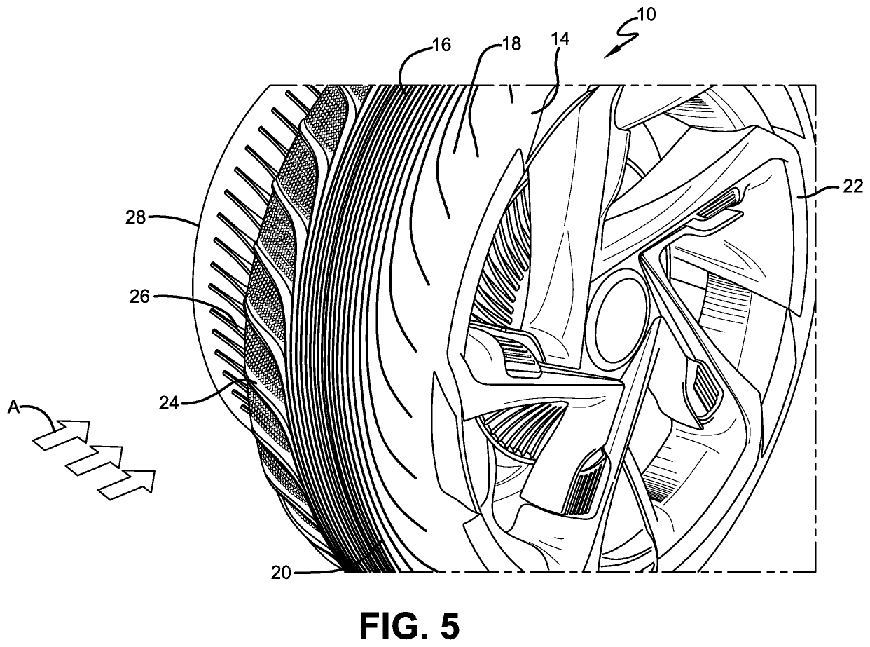

A second aspect or feature preferably includes physical features 24 formed on the tread 20. Each physical feature 24 is formed in the shape of a fin, vane or blade. As shown in FIGS. 5 through 8, each physical feature 24 extends from an area of the tread 20 near the equatorial plane to the inboard shoulder 18a to increase the air flow, represented by arrows indicated at A, driven towards the electric vehicle motor disposed inboardly of the rim or wheel 22. Preferably, an angle of the each physical feature 24 relative to the axis of rotation of the tire 10 is between about zero (0) degrees and about ninety (90) degrees, and more preferably, corresponds to or matches an angle of fins or vanes 26 formed on a turbine 28 of the electric vehicle motor or on the wheel 22 to further increase cooling efficiency.

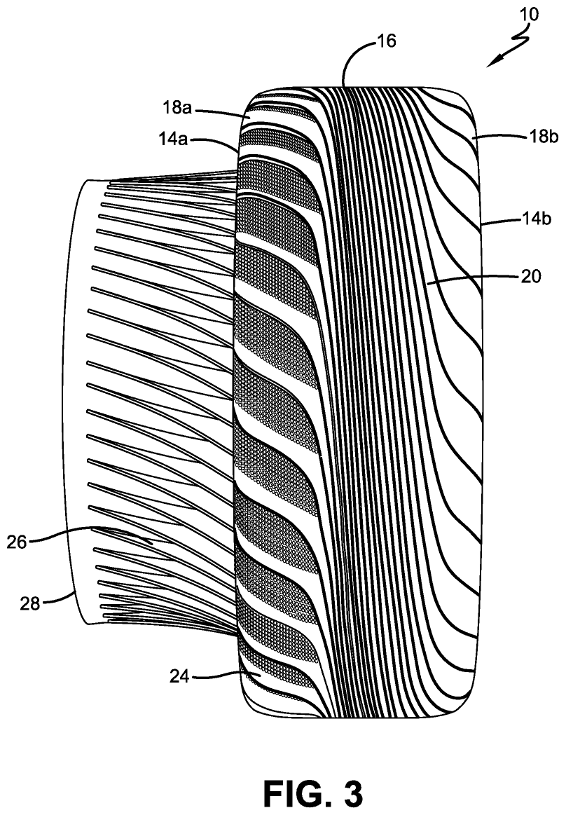

A third aspect or feature includes an outside or exterior shape of the tire 10 that reduces aerodynamic drag to enhance the battery range of the vehicle, as shown in FIGS. 3 and 4. Preferably, the radius R2 of the outboard shoulder 18b of the tire 10 is smaller than the radius R1 of the inboard shoulder 18a, which reduces aerodynamic drag of the tire, thereby increasing the battery range of the vehicle. In addition, an asymmetric cavity 30, which is a cavity with an asymmetric cross section, preferably is formed when the tire 10 is mounted on the wheel 22, thereby reducing aerodynamic drag of the tire.

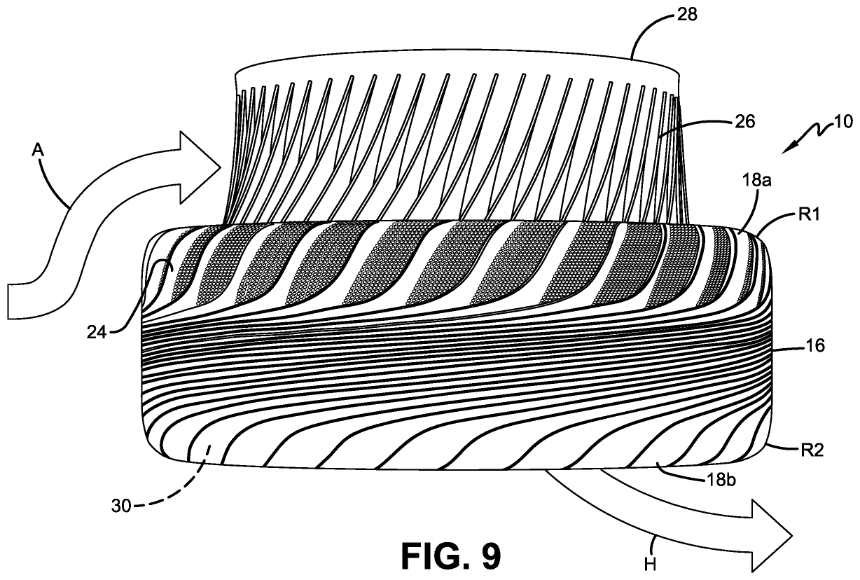

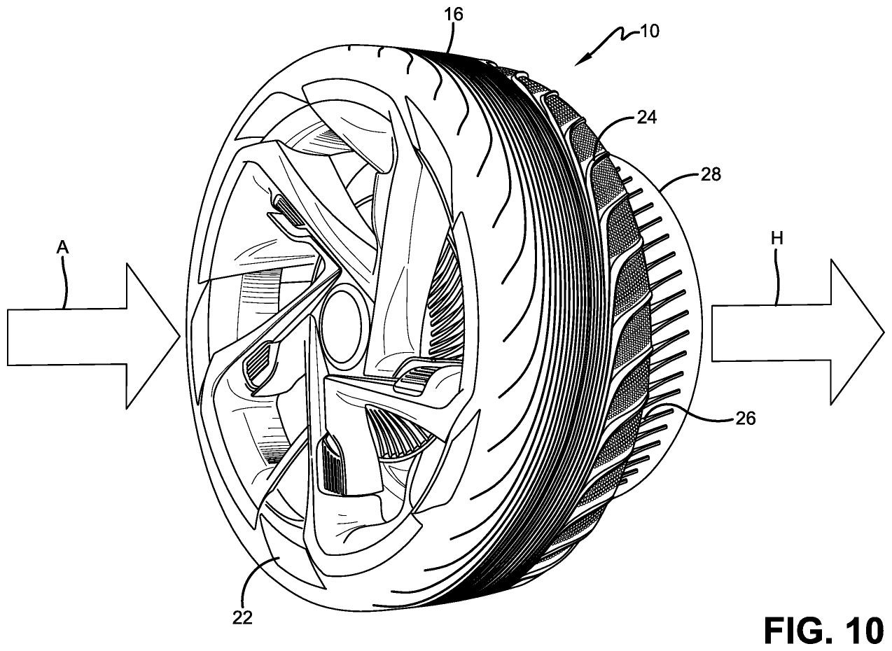

A fourth aspect or feature includes an aerodynamic shape of the tire 10 with structural features that promote the extraction of heat through the rim or wheel 22, as shown in FIGS. 9 and 10. More particularly, the combination of the radius R2 of the outboard shoulder 18b of the tire 10 being smaller than the radius R1 of the inboard shoulder 18a and the physical features 24 formed on the tread 20 enable increased air flow and promote the extraction of heat, indicated at arrow H, through the rim or wheel 22.

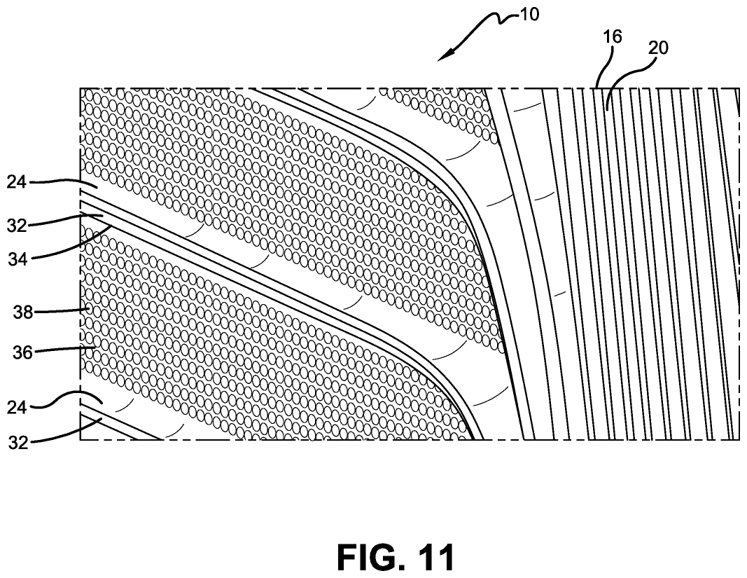

A fifth aspect or feature includes micro-features 34 to reduce air noise, as shown in FIG. 11. Each physical feature 24 formed on the tread includes a leading edge 32. The leading edge 32 of at least some of the physical features or fins 24 is covered with the micro-features 34. Preferably, the micro-features 34 are formed as structural small or tiny hairs, which reduce air noise. More preferably, the leading edge 32 of each physical feature or fin 24 is covered with a texture of micro hairs 34, which absorb impact noise from the air.

A base area 36 between each respective physical feature or fin 24 may also be formed with a plurality of micro-features 38. The micro-features 38 formed in each base area 36 may be formed as structural small or tiny hairs, which reduce air noise. The micro-features 38 may be of different sizes, depending on particular design considerations for the tire 10.

The effectiveness of the above-described features of the tire 10 has been confirmed through testing using aerodynamic simulations.

The present invention also includes a method of forming a tire 10 with features for an electric vehicle. The method includes steps in accordance with the description that is presented above and shown in FIG. 1 through 11.

It is to be understood that the structure of the above-described tire may be altered or rearranged, or components or steps known to those skilled in the art omitted or added, without affecting the overall concept or operation of the invention. For example, the teachings herein are applicable to a broad range of tires and may be useful in tire lines such as, but not limited to, passenger tires, radial medium truck tires, aircraft tires, and off-the-road tires, run-flat tires, and the like.

The invention has been described with reference to a preferred embodiment. Potential modifications and alterations will occur to others upon a reading and understanding of this description. It is to be understood that all such modifications and alterations are included in the scope of the invention as set forth in the appended claims, or the equivalents thereof.

What is claimed is:

1. A pneumatic tire for an electric vehicle, the tire comprising:
a pair of bead areas;
a ground-contacting tread disposed radially outwardly of the pair of bead areas;
a pair of sidewalls, in which each sidewall extends from a respective bead area to the tread; and
the tread joining each sidewall at a respective shoulder, the shoulders including an inboard shoulder and an outboard shoulder, wherein a radius on the inboard shoulder is larger than a radius on the outboard shoulder.

2. The pneumatic tire for an electric vehicle of claim 1, wherein a cavity is defined when the tire is mounted on a rim, the cavity including an asymmetric cross section.

3. A pneumatic tire for an electric vehicle, the tire comprising:
a pair of bead areas;
a ground-contacting tread disposed radially outwardly of the pair of bead areas;
a pair of sidewalls, in which each sidewall extends from a respective bead area to the tread; and
physical features being formed on the tread, wherein each feature is formed in the shape of a fin, whereby the features increase air flow towards an electric vehicle motor located inboardly of the tire.

4. The pneumatic tire for an electric vehicle of claim 3, wherein an angle of each fin corresponds to an angle of fins formed on a turbine of a motor of the electric vehicle.

5. A pneumatic tire for an electric vehicle, the tire comprising:
a pair of bead areas;
a ground-contacting tread disposed radially outwardly of the pair of bead areas;
a pair of sidewalls, in which each sidewall extends from a respective bead area to the tread; and
physical features being formed on the tread, wherein each feature is formed in the shape of a fin, at least one of the fins including a leading edge formed with micro-features.

6. The pneumatic tire for an electric vehicle of claim 5, wherein each of the fins includes a leading edge, and each leading edge is formed with micro-features.
